(19) United States
(12) Patent Application Publication
(10) Pub. No.: US 2013/0144763 A1
(43) Pub. Date: Jun. 6, 2013

(54) ASSISTED SHIPPING SYSTEM

(71) Applicants: Rolf Skyberg, Campbell, CA (US); Ryan Melcher, Ben Lomond, CA (US); Sri Harsha Chevuru, San Jose, CA (US); Muralidhara Reddy Beedala, Sunnyvale, CA (US); Chethan Narayan, San Jose, CA (US)

(72) Inventors: Rolf Skyberg, Campbell, CA (US); Ryan Melcher, Ben Lomond, CA (US); Sri Harsha Chevuru, San Jose, CA (US); Muralidhara Reddy Beedala, Sunnyvale, CA (US); Chethan Narayan, San Jose, CA (US)

(73) Assignee: eBay Inc., San Jose, CA (US)

(21) Appl. No.: 13/309,858

(22) Filed: Dec. 2, 2011

(51) Int. Cl. G06Q 30/00; G06Q 50/28

(52) U.S. Cl. 705/27.1

(57) ABSTRACT

An assisted shipping system is described. Physical specifications of the item to be listed in an online marketplace are determined. Specifications of a shipping material for the item are determined based on the physical specifications of the item. A recommended shipping means is generated based on the specifications of the shipping material and the physical specifications of the item. Historical shipping information for shipped items previously listed on the online marketplace are stored. The physical specifications of the item, the specifications of the shipping material for the item, or the recommended shipping means may be determined based on the historical shipping information.

### TECHNICAL FIELD

This application relates generally to the field of computer technology, and in a specific example embodiment, to a system and method for assisting a shipping process.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

However, the seller is faced with a variety of tasks when preparing to ship the item. The seller must first determine the appropriate box size. Once the item has been packaged, the seller must choose among the different shipping choices available to the seller. The seller then needs to obtain the appropriate shipping label and fill it out with shipping information from the buyer. When the seller finally ships the package, the seller further needs to provide a tracking number to the buyer by copying the tracking number and emailing it to the buyer. This shipping process therefore impedes on the seller's efficiency to ship items and can cause much frustration and wasted time.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of an assisted shipping application;

FIG. 3 is a block diagram illustrating an example embodiment of an item specification generator;

FIG. 4 is a block diagram illustrating an example embodiment of a shipping material provisioning engine;

FIG. 5 is a block diagram illustrating an example embodiment of a shipping recommendation engine;

FIG. 6 is a block diagram illustrating an example embodiment of a shipping tracking engine;

FIG. 7 is a flow diagram illustrating an example of a process for an assisted shipping application;

FIG. 8 is a flow diagram illustrating an example of another process for an assisted shipping application;

FIG. 9 is a flow diagram illustrating another example of yet another process for an assisted shipping application;

FIG. 10 is a flow chart of one embodiment of a method for providing assisted shipping;

FIG. 11A is a flow chart of one embodiment of a method for determining physical specifications of an item;

FIG. 11B is a flow chart of another embodiment of a method for determining physical specifications of an item;

FIG. 11C is a flow chart of a further embodiment of a method for determining physical specifications of an item;

FIG. 12 is a flow chart of one embodiment of a method for provisioning shipping material for an item;

FIG. 13 is a flow chart of one embodiment of a method for generating a recommendation for a shipping means for an item;

FIG. 14 is a flow chart of one embodiment of a method for tracking a shipping status of an item; and

FIG. 15 shows a diagrammatic representation of machine in the example form of a computer system within which a set of instructions may be executed to cause the machine to perform any one or more of the methodologies discussed herein.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In various embodiments, a system and method for assisted shipping is provided. An assisted shipping system is described. Physical specifications of an item to be listed in an online marketplace are determined. Specifications of a shipping material for the item are determined based on the physical specifications of the item. A recommended shipping means is generated based on the specifications of the shipping material and the physical specifications of the item. Historical shipping information for shipped items previously listed on the online marketplace are stored. The physical specifications of the item, the specifications of the shipping material for the item, or the recommended shipping means may be determined using the historical shipping information. For example, an item to be listed may be looked up in a database of historical shipping information to determine previously used shipping box size, shipping material, shipping carriers, and shipping services that may be applicable to the item to be listed.

In one embodiment, the assisted shipping system has an item specification generator, a shipping material provisioning engine, a shipping recommendation engine, and a storage device. The item specification generator determines physical specifications of the item to be listed in an online marketplace. Physical specifications may include, for example, physical dimensions (e.g., height, width, length, and weight). The shipping material provisioning engine determines specifications of a shipping material for the item based on the physical specifications of the item. In other words, a size of a shipping box may be selected such that it will fit the item and not be too large so as to waste shipping space. The shipping recommendation engine generates a recommended shipping means based on the specifications of the shipping material and the physical specifications of the item. The recommended shipping means may include identification of a shipping carrier and types of services (e.g., parcel mail, express mail, two-day delivery, and so forth). The storage device may include historical shipping information of shipped items previously listed on the online marketplace. The physical specifications of the item, the specifications of the shipping material for the item, or the recommended shipping means may be determined based on the historical shipping information. For example, an item to be listed may be looked up in a database of historical shipping information to determine previously used shipping box size, shipping material, shipping carriers, and shipping services that may be applicable to the item to be listed.

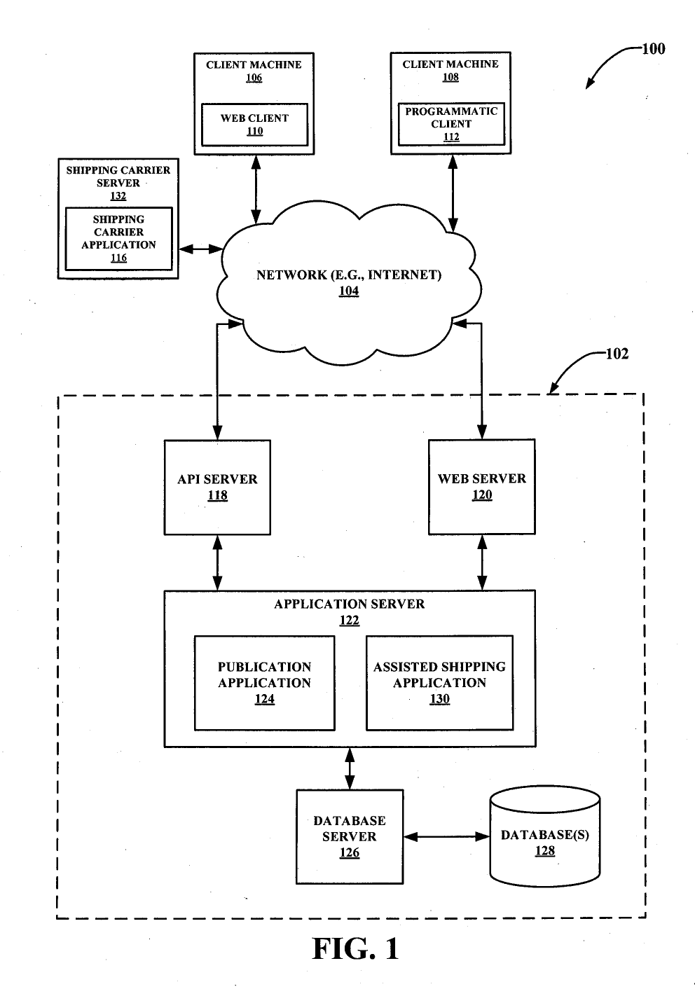

FIG. 1 is a network diagram depicting a network system 100, according to one embodiment, having a client-server architecture configured for exchanging data over a network. For example, the network system 100 comprises a network-based publisher 102, where clients may communicate and exchange data within the network system 100. The data may pertain to various functions (e.g., online item purchases) and aspects (e.g., managing order information) associated with the network system 100 and its users. Although illustrated herein as a client-server architecture as an example, other embodiments may include other network architectures, such as, a peer-to-peer or distributed network environment.

A data exchange platform, in an example form of the network-based publisher 102, may provide server-side functionality, via a network 104 (e.g., the Internet), to one or more clients. The one or more clients may include users that utilize the network system 100 and, more specifically, the publication/publisher system 102, to exchange data over the network 104. These transactions may include transmitting, receiving (communicating), and processing data to, from, and regarding content and users of the network system 100. The data may include, but are not limited to, content and user data such as order and shipping tracking information; item information; user profiles; user attributes; user reputation values; product and service reviews and information (such as pricing and descriptive information); product, service, manufacturer, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client (e.g., web browser) 110. The web client 110 may be in communication with the network-based publisher 102 via a web server 120. The UIs may also be associated with a client machine 108 using a programmatic client 112, such as a client application. It can be appreciated that in various embodiments, the client machines 106 and 108 may be associated with a buyer, a seller, a third party electronic commerce platform, and/or a payment service provider. The buyers and sellers may be any one of individuals, merchants, or service providers, among other things.

Furthermore, a shipping carrier server 132 of a shipping service provider may be in communication with the network-based publisher 102 and optionally with client machines 106 and 108. The shipping carrier server 132 includes a shipping carrier application 116 to provide a shipping tracking mechanism to the client machines 106 and 108 and an application server 122 of the network-based publisher 102. The shipping tracking mechanism allows the client machines 106 and 108 and the application server 122 to determine a status of a shipment for an item associated with an order placed by a buyer of the network-based publisher 102.

Turning specifically to the network-based publisher 102, an application program interface (API) server 118 and a web server 120 are coupled to, and provide programmatic and web interfaces respectively to, one or more application servers 122. The application servers 122 host a publication application 124 and an assisted shipping application 130. The application servers 122 are, in turn, shown to be coupled to one or more database server(s) 126 that facilitate access to one or more database(s) 128.

In one embodiment, the web server 120 and the API server 118 communicate about and receive data pertaining to listings, transactions, order tracking information, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., web client 110 or shipping carrier application 116) running on another client machine (e.g., shipping carrier server 132).

The publication application 124 may provide a number of publisher functions and services (e.g., listing, payment, etc.) to users that access the network-based publisher 102. For example, the publication application 124 may provide a number of services and functions to users for listing goods and/or services for sale, facilitating transactions, and reviewing and providing feedback about transactions and associated users. The publication application 124 may further report a shipment status related to a transaction. In one embodiment, the publication application 124 includes an online marketplace.

The assisted shipping application 130 provides assistance to a seller of an online marketplace to provision the shipping material and select the shipping service to ship the item to the buyer. An embodiment of the assisted shipping application 130 is further described below.

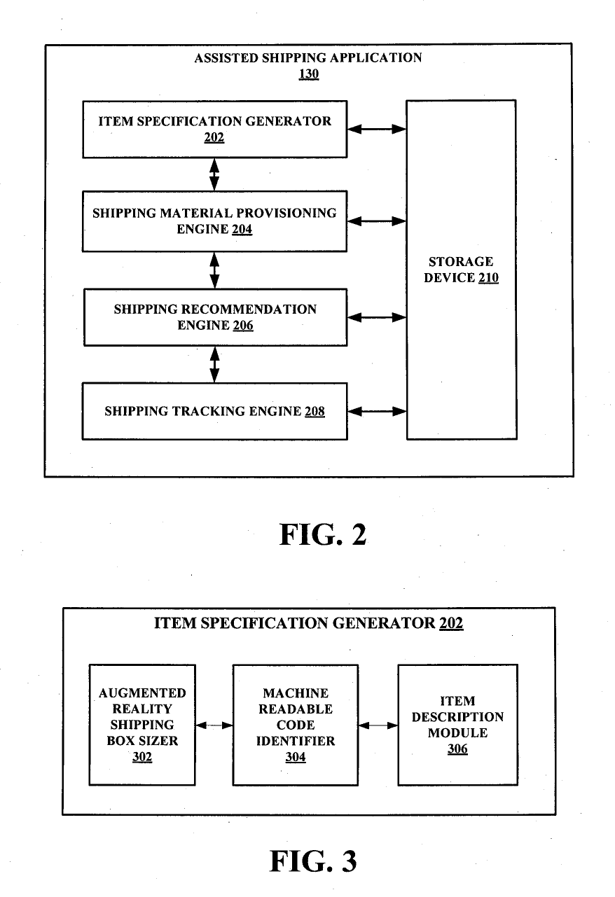

FIG. 2 is a block diagram illustrating an example embodiment of the assisted shipping application 130. In one embodiment, the assisted shipping application 130 includes an item specification generator 202, a shipping material provisioning engine 204, a shipping recommendation engine 206, a shipping tracking engine 208, and a storage device 210.

The item specification generator 202 determines physical specifications of the item listed (or to be listed) on the online marketplace. Physical specifications may include for example, physical dimensions (e.g., height, width, length, and weight). Physical dimensions may be deduced or derived, for example, from a picture or video of the item taken with a mobile device of the seller. An embodiment of the item specification generator 202 is further described below with respect to FIG. 3.

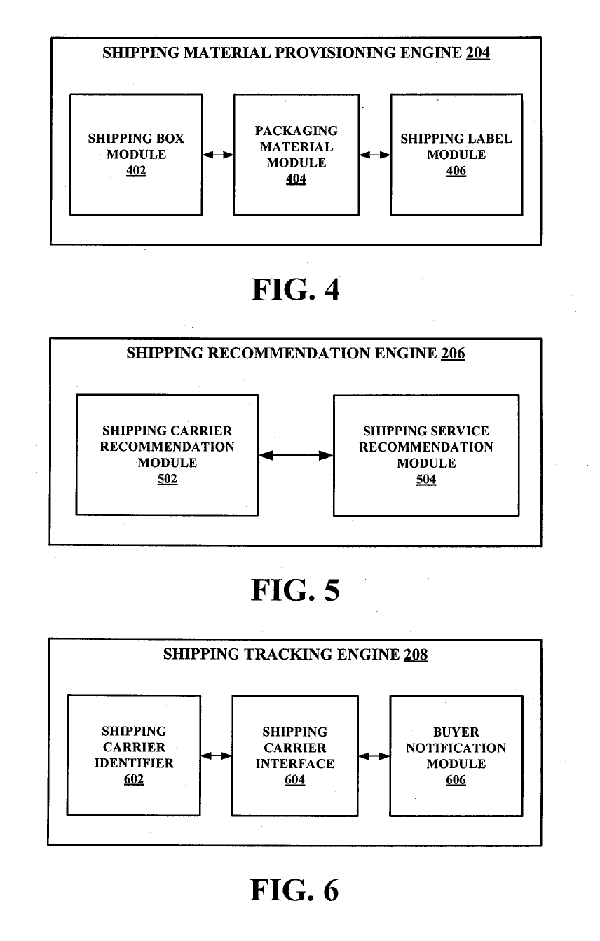

The shipping material provisioning engine 204 determines specifications of a shipping material for the item based on the physical specifications of the item. In other words, a size of a shipping box may be selected such that it will fit the item and not be too large so as to waste shipping space. Additionally, material needed to fill the shipping box and protect the item may also be determined based on the size and weight of the item and size of the shipping box. An embodiment of the shipping material provisioning engine 204 is further described below with respect to FIG. 4.

The shipping recommendation engine 206 generates a recommended shipping means based on the specifications of the shipping material and the physical specifications of the item. The recommended shipping means may include the identification of a shipping carrier and types of service (e.g., parcel mail, express mail, two-day delivery, and so forth).

The storage device 210 may include historical shipping information of shipped items previously listed on the online marketplace. The physical specifications of the item, the specifications of the shipping material for the item, or the recommended shipping means may be determined using the historical shipping information. An embodiment of the shipping recommendation engine 206 is further described below with respect to FIG. 5.

The shipping tracking engine 208 tracks a shipping status of the item. The shipping status may be a time and a corresponding location of the item. An embodiment of the shipping tracking engine 208 is further described below with respect to FIG. 6.

The storage device 210 includes, for example, a database of previously listed items, corresponding machine readable code information, corresponding physical dimensions, corresponding shipping carriers, and corresponding shipping services. In other words, items similar to the item to be listed may be looked up in the database to determine previously used shipping box size, shipping material, shipping carriers, and shipping services. Feedback from the different shipping experiences may also be collected. For example, sellers may provide satisfaction rankings of their shipping experience. Such feedback may be later used to adjust shipping recommendations from the shipping recommendation engine 206. In an alternative embodiment, the storage device 210 may be located elsewhere in the network system 100.

FIG. 3 is a block diagram illustrating an example embodiment of the item specification generator 202 of FIG. 2. In one embodiment, the item specification generator 202 includes an augmented reality shipping box sizer 302, a machine readable code identifier 304, and an item description module 306. In another embodiment, a mechanical device may be coupled to the mobile device of the seller. The mechanical device may be configured to detect a weight of the item to be listed on the online marketplace. The detected weight may be electronically or manually communicated to the mobile device of the seller.

The augmented reality shipping box sizer 302 may request the seller to place a glyph adjacent to (e.g., next to, on top of, and so forth) the item to be listed on the online marketplace. The glyph may be an object with predefined dimensions known to the augmented reality shipping box sizer 302 that is already in the possession of the seller, such as a credit card, a driver's license, and so forth. The seller then takes a picture of the glyph with the item. In one embodiment, the entire glyph and the entire item are visible in the picture. The picture may be taken from different angles (top view, side view, perspective view, and so forth). In another example, the item may be placed on a typical household scale. A picture of the item on the scale will provide not only a size estimation of the item but also the weight of the item since the scale can display the weight of the item. The augmented reality shipping box sizer 302 can then extrapolate the physical dimensions of the item based on the predefined physical dimensions of the glyph.

The machine readable code identifier 304 receives a machine readable code information associated with the item and determines physical dimensions of the item based on the machine readable code information. For example, the machine readable code identifier 304 may receive information the mobile device scanning a bar code, UPS, or QR code on the item to be listed. The seller may take a picture of the machine readable code with his/her mobile device, manually enter the machine readable on his/her mobile device, or scan the machine readable code with his/her mobile device which then sends the information to the machine readable code identifier 304. The bar code may be located on the item or on the product package of the item. For example, a laptop computer may include a bar code label on the back of the laptop computer. In another example, the bar code may be located on the product box of a portable music player instead of the portable music player itself. In another embodiment, the item specification generator 202 may ask the seller whether the item includes the original product box or just the item itself so that the appropriate shipping box and materials may be determined.

Once the machine readable code identifier 304 receives the machine readable code associated with the item, the machine readable code identifier 304 consults the historical shipping information from the storage device to determine the physical dimensions of an item having the same code. In another embodiment, the machine readable code identifier 304 communicates with another storage device that may include a library or repository of product codes with their corresponding specifications and physical dimensions.

The item description module 306 analyzes a written description of the item to be listed. For example, the seller may provide a category and a written description of the item to be listed. The category may be for example, electronic music player. The written description may include the brand name and model number of the electronic music player. The item description module 306 then determines the physical dimensions of the item based on the written description provided by the seller. The physical dimensions of the item may be determined by comparing the written description with a database of previously listed items, corresponding written description, and corresponding physical dimensions (e.g., the historical shipping information). In one embodiment, the database may be stored in the storage device 210 of FIG. 2. In an alternative embodiment, the written description may include estimated dimensions and weights. The item description module 306 may thus extract this information to determine corresponding physical dimensions.

FIG. 4 is a block diagram illustrating an example embodiment of the shipping material provisioning engine 204 of FIG. 2. In one embodiment, the shipping material provisioning engine 204 comprises a shipping box module 402, a packaging material module 404, and a shipping label module 406.

The shipping box module 402 identifies a size of a shipping box based on the physical specifications of the item as determined by the item specification generator 202. Shipping boxes may be available in a variety of sizes. The shipping box module 402 may use an algorithm to determine the most optimal box size to fit the item (with or without the product package).

The packaging material module 404 identifies packaging material to be included with the item in the shipping box. The packaging material may include Styrofoam peanuts, air-filled bags, and so forth. The amount of shipping material may be determined based on the dimensions of the item and the dimensions of the recommended shipping box.

The shipping label module 406 generates a shipping label based on the recommended shipping means for the item. In one embodiment, the shipping label generator 406 may affix a preprinted shipping label on the recommended shipping box. The preprinted shipping label may include the buyer's address, item listing information, and/or an identification of a shipping carrier or a shipping service.

FIG. 5 is a block diagram illustrating an example embodiment of the shipping recommendation engine 206 of FIG. 2. The shipping recommendation engine 206 may include a shipping carrier recommendation module 502 and a shipping service recommendation module 504.

The shipping carrier recommendation module 502 identifies a shipping carrier based on the specifications of the shipping material for the item and the physical specifications of the item, a shipping address of a seller of the item, a destination address of a buyer of the item, and historical shipping information for similar shipped items previously listed on the online marketplace. For example, shipping carrier recommendation module 502 may recommend a specific shipping carrier that is capable of shipping the item from the shipping address of the seller to the destination address of the buyer. Some shipping carriers may provide shipping services limited to specific geographic regions. In another example, the shipping carrier recommendation module 502 may recommend a specific shipping carrier based on the historical shipping information. For example, a similar item may have been shipped from a physical location close to the shipping address of the seller to a physical location close to the destination address of the buyer with a particular shipping carrier. The particular shipping carrier may have received a positive feedback from the seller and the buyer. As such, the shipping carrier recommendation module 502 may recommend the same shipping carrier.

The shipping service recommendation module 504 generates a recommendation of a shipping service of the shipping carrier based on the specifications of the shipping material for the item, the physical specifications of the item, and historical shipping information for similar shipped items previously listed on the online marketplace. For example, the shipping service recommendation module 504 may recommend a specific shipping service for shipping the item with the recommended shipping carrier. The shipping service may include for example a two day delivery service, a one-day delivery service, a ground delivery service, and air delivery service, a flat rate delivery service, and so forth. The shipping service recommendation may be based on a similar item that has been shipped from a physical location close to the shipping address of the seller to a physical location close to the destination address of the buyer with a particular shipping service from the recommended shipping carrier. The particular shipping service may not necessarily be the lowest price service. For a little more cost, the shipping service can be upgraded from a parcel delivery service to a two day delivery service. As such, more than one recommendation may be generated to the seller: a recommendation based on the lowest cost (identifying the shipping carrier and corresponding shipping service), a recommendation based on the best value (cost and speed), and a recommendation based on speed.

FIG. 6 is a block diagram illustrating an example embodiment of the shipping tracking engine 208 of FIG. 2. The shipping tracking engine 208 tracks a shipping status of the item. In one embodiment, the shipping tracking engine 208 includes a shipping carrier identifier 602, a shipping carrier interface 604, and a buyer notification module 606. The shipping carrier identifier 602 identifies a shipping carrier based on information from a machine readable code of a shipping label for the item. The shipping carrier interface 604 communicates with the identified shipping carrier to update the shipping status of the item based on the machine readable code of the shipping label. The buyer notification module 606 notifies a buyer of a status of the item when, for example, the seller of the item scans the shipping label for the item. In another embodiment, the buyer notification module 606 notifies the buyer of shipping status changes (e.g, picked up, in route, at a certain shipping location, out for delivery, etc. . . . ).

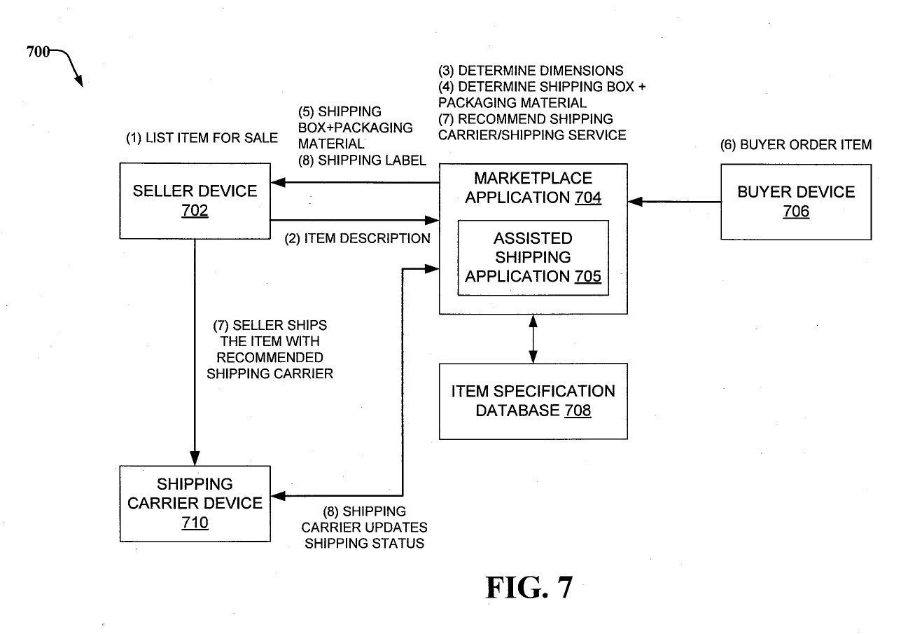

FIG. 7 is a flow diagram illustrating an example of a process of an assisted shipping application 705. A seller device 702 submits a description of an item to be listed with the online marketplace application 704. The online marketplace application 704 may include the assisted shipping application 705. The assisted shipping application 705 determines the physical dimensions of the item based on the description of the item by comparing the description of the item with the description of similar items from an item specification database 708. The assisted shipping application 705 determines a size of a shipping box and an amount of packaging material based on the physical dimensions of the item as described above. The shipping box and the packaging material may be shipped to the seller prior to determining the recommended shipping carrier and shipping service since that recommendation is based on the information of a buyer.

A buyer device 706 places an order for the item on the online marketplace application 705. The buyer device 706 provides information that includes a destination address. The assisted shipping application 705 recommends a shipping carrier and a shipping service based on the destination address of the buyer, the address of the seller device 702, the physical dimensions of the item, and/or the shipping history of similar items from database 708. The seller device 702 receives/prints a shipping label generated by the assisted shipping application 705. The shipping label may be preprinted with information concerning the seller, the buyer, the item, the recommended shipping carrier, and the recommend shipping service. The seller device 702 then packs the item with the packaging material in the provided shipping box. The seller device 702 affixes the shipping label on the provided shipping box.

In one embodiment the seller device 702 may scan a machine-readable code on the shipping label with a mobile device of the seller device 702 prior to providing the shipping box to a shipping carrier. An application in the mobile device of the seller device 702 reads the machine-readable code and transmits the information from the machine-readable code to the assisted shipping application 705 to indicate that the item has left the seller device 702. The assisted shipping application 705 may forward the shipping status of the item to the buyer device 706. In another embodiment, a shipping carrier device 710 may update the shipping status of the item to the assisted shipping application 705 and the buyer 706.

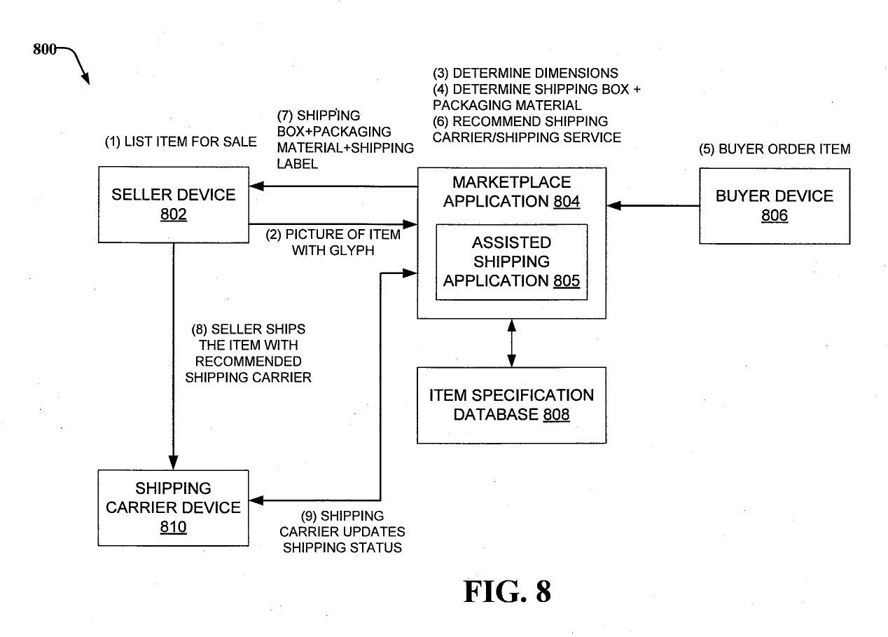

FIG. 8 is a flow diagram illustrating an example of another process of an assisted shipping application 805. A seller device 802 submits a description of an item to be listed with an online marketplace application 804. The online marketplace application 804 may include the assisted shipping application 805. The assisted shipping application 805 receives a picture of the item positioned next to a glyph from a mobile device of the seller device 702. The assisted shipping application 805 extrapolates the physical dimensions of the item based on the received picture. The assisted shipping application 805 determines a size of a shipping box and an amount of packaging material based on the physical dimensions of the item determined using the glyph. A buyer device 806 places an order for the item on the online marketplace application 805.

The assisted shipping application 805 generates a recommendation of a shipping carrier and a shipping service based on the information from the buyer device 806, the seller device 802, and the shipping history of similar items from database 808. Upon selection of a shipping carrier and shipping service by the seller device 802, the shipping box, the packaging material, and a preprinted shipping label comprising information about the shipping carrier, the shipping service, the buyer 806, and the seller are shipped to the seller. Upon receipt of the packaging kit, the seller packs the item in the shipping box along with the provided packaging material. The seller then affixes the shipping label on the provided shipping box.

In one embodiment the seller device 802 may scan a machine-readable code on the shipping label with a mobile device of the seller device 802 prior to providing the shipping box to a shipping carrier. An application in the mobile device of the seller device 802 reads the machine-readable code and transmits the information from the machine-readable code to the assisted shipping application 805 to indicate that the item has left the seller device 802. The assisted shipping application 805 may forward the shipping status of the item to the buyer device 806. In another embodiment, a shipping carrier device 810 may update the shipping status of the item to the assisted shipping application 805 and the buyer device 806.

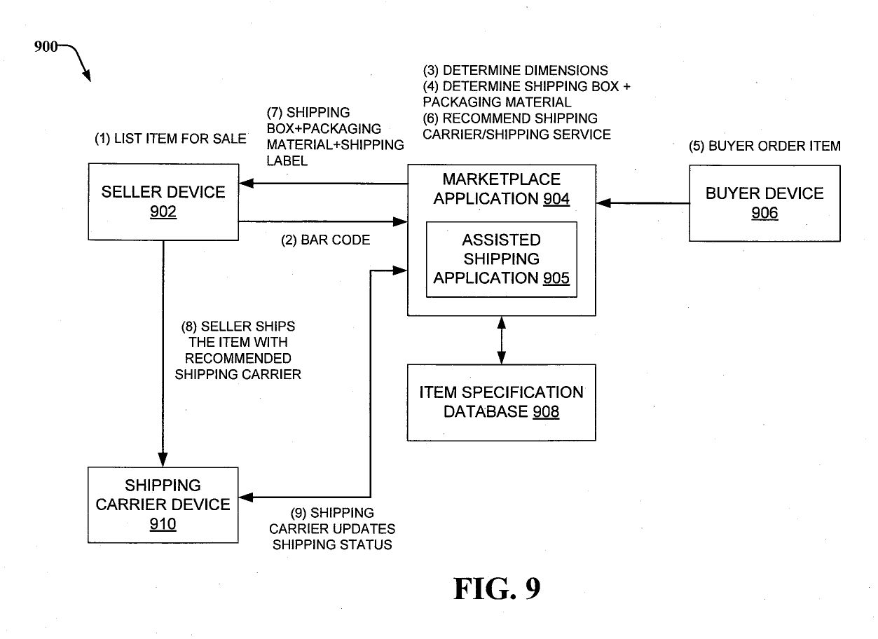

FIG. 9 is a flow diagram 900 illustrating another example of yet another process for an assisted shipping application 905. A seller device 902 submits a description of an item to be listed with the online marketplace application 904. The online marketplace application 904 may include the assisted shipping application 905. The assisted shipping application 905 receives a picture of machine-readable code on the item (or product package of the item) from a mobile device of the seller device 902. The assisted shipping application 905 determines the physical dimensions of the item based on the information in an item specification database 908 using the machine-readable code. The information in the item specification database 908 may include item identifications, corresponding descriptions, corresponding machine-readable code, corresponding physical specifications, corresponding shipping box sizes, and so forth.

The assisted shipping application 905 determines a size of the shipping box and an amount of packaging material based on the physical dimensions of the item determined using the item specification database 908. A buyer device 906 places an order for the item on the online marketplace application 905. The assisted shipping application 905 generates a recommendation of a shipping carrier and a shipping service based on the information from the buyer device 906, the seller device 902, and the shipping history of similar items from database 908. Upon a selection of a shipping carrier and shipping service by the seller device 902, the shipping box, the packaging material, and a preprinted shipping label comprising information about the shipping carrier, the shipping service, the buyer, and the seller are shipped to the seller. Upon receipt of the packaging kit, the seller device 902 packs the item in the shipping box along with the provided packaging material. The seller device 902 affixes the shipping label on the provided shipping box.

In one embodiment the seller device 902 may scan a machine-readable code on the shipping label with a mobile device of the seller device 902 prior to providing the shipping box to the shipping carrier. An application in the mobile device of the seller device 902 reads the machine-readable code and transmits the information from the machine-readable code to the assisted shipping application 905 to indicate that the item has left the seller device 902. The assisted shipping application 905 may forward the shipping status of the item to the buyer device 906.

In another embodiment, a shipping carrier device 910 may update the shipping status of the item to the assisted shipping application 905 and the buyer device 906.

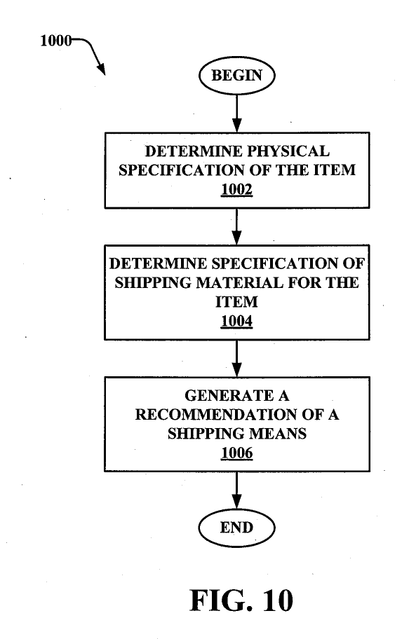

FIG. 10 is a flow chart 1000 of one embodiment of a method for providing assisted shipping. At 1002, physical specifications of an item to be listed in an online marketplace are determined. At 1004, specifications of a shipping material for the item are determined based on the physical specifications of the item. At 1006, a recommended shipping means is generated based on the specifications of the shipping material and the physical specifications of the item. The historical shipping information for shipped items previously listed on the online marketplace is stored in a storage device. The physical specifications of the item, the specifications of the shipping material for the item, or the recommended shipping means may be determined based in part on the historical shipping information.

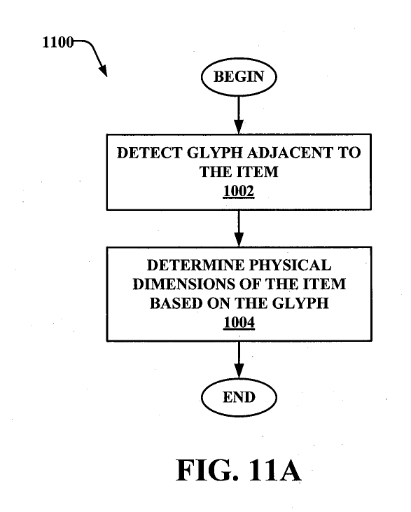

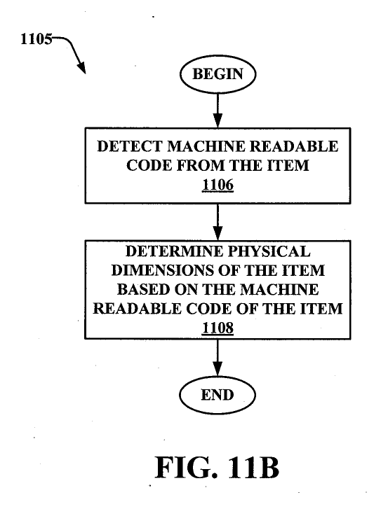

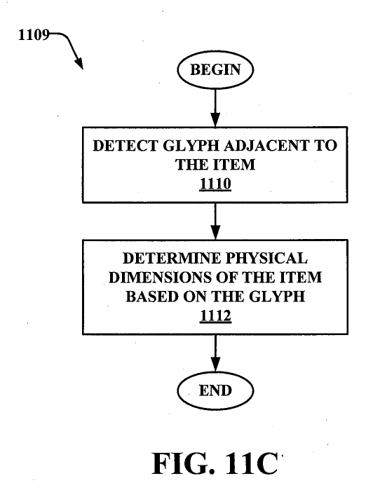

FIG. 11A is a flow chart 1100 of one embodiment of a method for determining physical specifications of an item. A glyph may be positioned adjacent to the item (e.g., on top, next to, and so forth). At 1102, a glyph adjacent to the item is detected. At 1104, the physical dimensions of the item are determined based on predefined physical dimensions of the glyph.

FIG. 11B is a flow chart 1105 of another embodiment of a method for determining physical specifications of an item. At 1106, machine readable code information associated with the item is received. At 1108, the physical dimensions of the item are determined based on the machine readable code information. For example, the storage device comprises a database of previously listed items, corresponding machine readable code information, and corresponding physical dimensions from which a lookup may be performed using the received machine readable code information.

FIG. 11C is a flow chart 1109 of another embodiment of a method for determining physical specifications of an item. At 1110, a written description of the item to be listed is analyzed. At 1112, the physical dimensions of the item are determined based on the written description. For example, the storage device comprises a database of previously listed items, corresponding written description, and corresponding physical dimensions from which a lookup may be performed using the analyzed written description information.

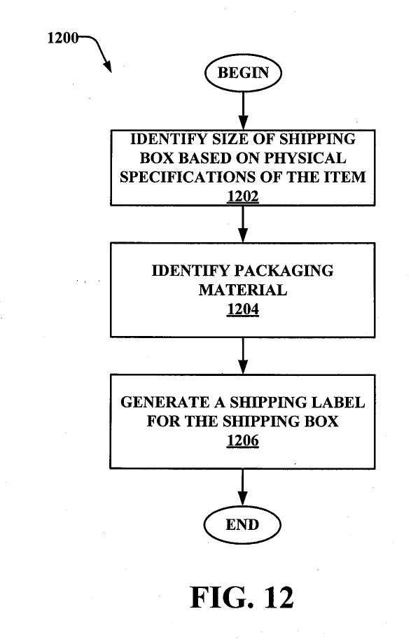

FIG. 12 is a flow chart 1200 of one embodiment of a method for provisioning shipping material for an item. At 1202, a size of a shipping box is identified based on the physical specifications of the item. At 1204, an amount of packaging material to be included with the item in the shipping box is determined. At 1206, a shipping label is generated based on the selection by the seller of a recommended shipping means for the item.

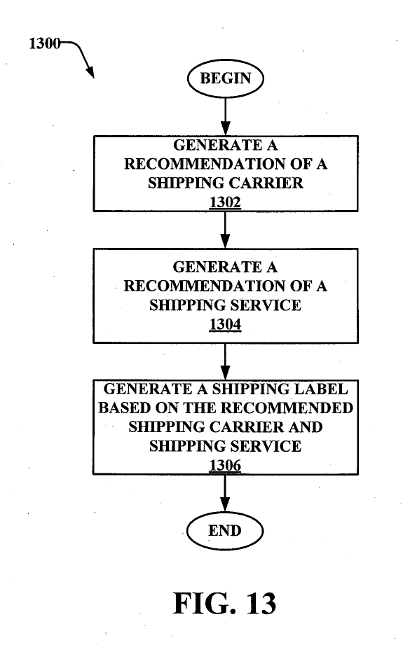

FIG. 13 is a flow chart 1300 of one embodiment of a method for generating a recommendation for a shipping means for an item. At 1302, a shipping carrier is identified based on the specifications of the shipping material for the item and the physical specifications of the item, a shipping address of a seller of the item, a destination address of a buyer of the item, and historical shipping information for similar shipped items previously listed on the online marketplace. At 1304, a recommendation of a shipping service of the shipping carrier is generated based on the specifications of the shipping material for the item, the physical specifications of the item, and historical shipping information for similar shipped items previously listed on the online marketplace. At 1306, a shipping label may be generated based on the recommended shipping carrier and shipping service.

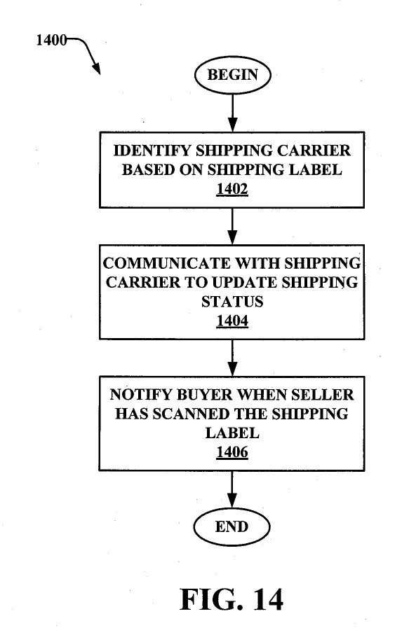

FIG. 14 is a flow chart 1400 of one embodiment of a method for tracking a shipping status of an item. At 1402, a shipping carrier is identified based on a code (e.g., machine readable code) of a shipping label for the item. At 1404, a shipping tracking module of the assisted shipping application communicates with the identified shipping carrier to obtain updates of the shipping status of the item based on the code of the shipping label. At 1406, the buyer of the item is notified when the seller of the item has scanned the shipping label for the item with a mobile device of the seller, or when the seller ships the item or provides the item to the shipping carrier.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems' (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

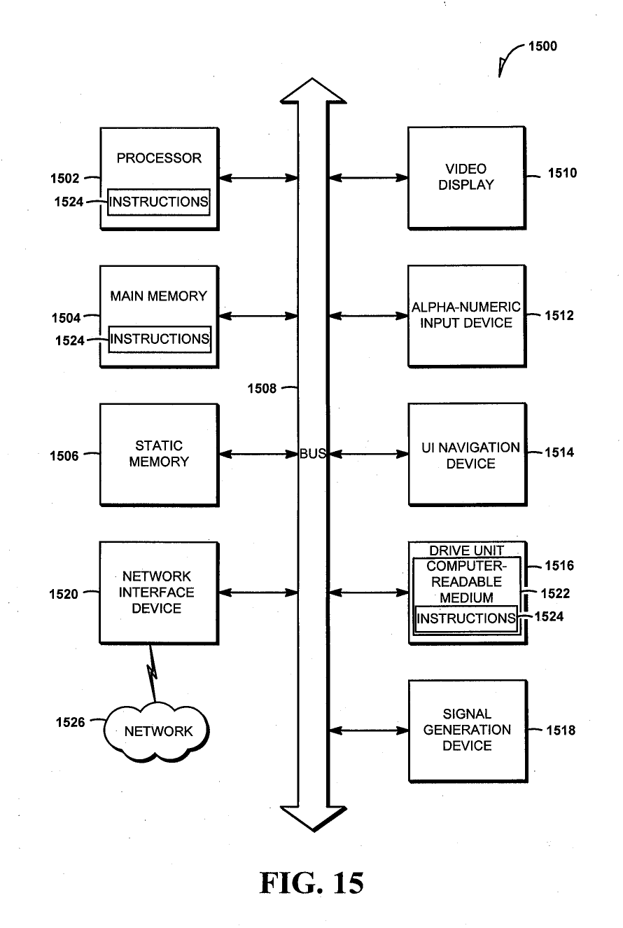

FIG. 15 shows a diagrammatic representation of a machine in the example form of a computer system 1500 within which a set of instructions, may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a user interface (UI) navigation device 1514 (e.g., a mouse), a disk drive unit 1516, a signal generation device 1518 (e.g., a speaker) and a network interface device 1520.

The disk drive unit 1516 includes a machine-readable medium 1522 on which is stored one or more sets of instructions and data structures (e.g., software 1524) embodying or utilized by any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media.

The software 1524 may further be transmitted or received over a network 1526 via the network interface device 1520 utilizing any one of a number of well-known transfer protocols (e.g., HTTP).

While the machine-readable medium 1522 is shown in an example embodiment to be a single medium, the term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “machine-readable medium” shall accordingly be taken to include, but not be limited to, solid-state memories, optical media, and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

What is claimed is:

1. An assisted shipping system comprising:
an item specification generator configured to determine physical specifications of an item to be listed in an online marketplace;
a shipping material provisioning engine configured to determine specifications of a shipping material for the item based on the physical specifications of the item;
a shipping recommendation engine configured to generate a recommended shipping means based on the specifications of the shipping material and the physical specifications of the item; and
a storage device comprising historical shipping information of shipped items previously listed on the online marketplace, the recommended shipping means determined based on the historical shipping information.

2. The assisted shipping system of claim 1, wherein the item specification generator comprises:
an augmented reality shipping box sizer configured to detect a glyph adjacent to the item in an image, and to determine the physical dimensions of the item based on predefined physical dimensions of the glyph.

3. The assisted shipping system of claim 1, wherein the item specification generator comprises:
a machine readable code identifier configured to receive an identifier associated with the item, and to determine the physical dimensions of the item based on the identifier by comparing the identifier to information stored in the storage device, the storage device comprising a database of previously listed items, corresponding identifier information, and corresponding physical dimensions.

4. The assisted shipping system of claim 1, wherein the item specification generator comprises:
an item description module configured to analyze a written description of the item to be listed, and to determine the physical dimensions of the item based on the written description by comparing the analyzed written description to information stored in the storage device, the storage device comprising a database of previously listed items, corresponding written description, and corresponding physical dimensions.

5. The assisted shipping system of claim 1, wherein the shipping material provisioning engine comprises:
a shipping box module configured to identify a size of a shipping box based on the physical specifications of the item;
a packaging material module configured to identify an amount of packaging material to be included with the item in the shipping box; and
a shipping label module configured to generate a shipping label based on a selection of the recommended shipping means for the item.

6. The assisted shipping system of claim 1, wherein the shipping recommendation engine comprises:
a shipping carrier recommendation module configured to identify a shipping carrier based on the specifications of the shipping material for the item and the physical specifications of the item, a shipping address of a seller of the item, a destination address of a buyer of the item, and historical shipping information for similar shipped items previously listed on the online marketplace; and
a shipping service recommendation module configured to generate a recommendation of a shipping service of the shipping carrier based on the specifications of the shipping material for the item, the physical specifications of the item, and historical shipping information for similar shipped items previously listed on the online marketplace.

7. The assisted shipping system of claim 1 further comprising:
a shipping tracking engine configured to track a shipping status of the item.

8. The assisted shipping system of claim 7 wherein the shipping tracking engine comprises:
a shipping carrier identifier configured to identify a shipping carrier based on an identifier on a shipping label for the item;
a shipping carrier interface configured to communicate with the identified shipping carrier to update the shipping status of the item based on the machine readable code of the shipping label; and
a buyer notification module configured to notify a buyer of a status of the item when the seller of the item has shipped the item.

9. A computer-implemented method comprising:
receiving information for listing an item on an online marketplace;
determining, using at least one processor, physical specifications of the item to be listed in the online marketplace from the information;
determining specifications of a shipping material for the item based on the physical specifications of the item;
generating a recommended shipping means based on the specifications of the shipping material and the physical specifications of the item; and
storing historical shipping information for shipped items previously listed on the online marketplace, the recommended shipping means determined based on the historical shipping information.

10. The computer-implemented method of claim 9, further comprising:
detecting a glyph adjacent to the item in an image; and
determining the physical dimensions of the item based on predefined physical dimensions of the glyph.

11. The computer-implemented method of claim 9, further comprising:
detecting an identifier associated with the item; and
determining the physical dimensions of the item based on the identifier by comparing the identifier to information stored in the storage device, the storage device comprising a database of previously listed items, corresponding machine readable code information, and corresponding physical dimensions.

12. The computer-implemented method of claim 9, further comprising:
analyzing a written description of the item to be listed; and
determining the physical dimensions of the item based on the written description by comparing the analyzed written description to information stored in the storage device, the storage device comprising a database of previously listed items, corresponding written description, and corresponding physical dimensions.

13. The computer-implemented method of claim 9, further comprising:
identifying a size of a shipping box based on the physical specifications of the item;
identifying a packaging material to be included with the item in the shipping box; and
generating a shipping label based on a selection of the recommended shipping means for the item.

14. The computer-implemented method of claim 9, further comprising:
identifying a shipping carrier based on the specifications of the shipping material for the item and the physical specifications of the item, a shipping address of a seller of the item, a destination address of a buyer of the item, and historical shipping information for similar shipped items previously listed on the online marketplace; and
generating a recommendation of a shipping service of the shipping carrier based on the specifications of the shipping material for the item, the physical specifications of the item, and historical shipping information for similar shipped items previously listed on the online marketplace.

15. The computer-implemented method of claim 9, further comprising:
tracking a shipping status of the item.

16. The computer-implemented method of claim 15, further comprising:
identifying a shipping carrier based on an identifier on a shipping label for the item;
communicating with the identified shipping carrier to receive updates of the shipping status of the item based on the identifier of the shipping label; and
notifying a buyer of the item when the seller of the item has shipped the item.

17. A non-transitory computer-readable storage medium storing a set of instructions that, when executed by a processor, cause the processor to perform operations, comprising:
receiving information for listing an item on an online marketplace;
determining physical specifications of the item to be listed in the online marketplace from the information;
determining specifications of a shipping material for the item based on the physical specifications of the item;
generating a recommended shipping means based on the specifications of the shipping material and the physical specifications of the item; and
storing historical shipping information for shipped items previously listed on the online marketplace, the recommended shipping means determined based on the historical shipping information.

18. The non-transitory computer-readable storage medium of claim 17, further comprising:
detecting a glyph adjacent to the item in an image; and
determining the physical dimensions of the item based on predefined physical dimensions of the glyph.

19. The non-transitory computer-readable storage medium of claim 17, further comprising:
detecting an identifier associated with the item; and
determining the physical dimensions of the item based on the identifier by comparing the identifier to information stored in the storage device, the storage device comprising a database of previously listed items, corresponding machine readable code information, and corresponding physical dimensions.

20. The non-transitory computer-readable storage medium of claim 17, further comprising:
analyzing a written description of the item to be listed; and
determining the physical dimensions of the item based on the written description by comparing the analyzed written description to information stored in the storage device, the storage device comprising a database of previously listed items, corresponding written description, and corresponding physical dimensions.

21. The computer-implemented method of claim 9, further comprising:
identifying a size of a shipping box based on the physical specifications of the item;
identifying a packaging material to be included with the item in the shipping box; and
generating a shipping label based on a selection of the recommended shipping means for the item.

22. The computer-implemented method of claim 17, further comprising:
identifying a shipping carrier based on the specifications of the shipping material for the item and the physical specifications of the item, a shipping address of a seller of the item, a destination address of a buyer of the item, and historical shipping information for similar shipped items previously listed on the online marketplace; and
generating a recommendation of a shipping service of the shipping carrier based on the specifications of the shipping material for the item, the physical specifications of the item, and historical shipping information for similar shipped items previously listed on the online marketplace
